(19) United States
(12) Patent Application Publication
(10) Pub. No.: US 2018/0057652 A1
(43) Pub. Date: Mar. 1, 2018

(54) SPONGE-FORMABLE SILICONE RUBBER COMPOSITION AND SILICONE RUBBER SPONGE

(71) Applicant: Dow Corning Toray Co., Ltd., Tokyo (JP)

(72) Inventor: Masakazu IRIE, Chiba (JP)

(21) Appl. No.: 15/551,206

(22) PCT Filed: Feb. 2, 2016
(86) PCT No.: PCT/JP2016/000535

§ 371 Date: Aug. 15, 2017

(30) Foreign Application Priority Data
Feb. 16, 2015 (JP) 2015-027387

(51) Int. Cl. C08J 9/00; C08J 9/28

(52) U.S. Cl. CPC C08J 9/0066; C08G 77/20; C08J 9/28; C08J 9/0061

(57) ABSTRACT

A sponge-formable silicone rubber composition of the present invention comprises (A) a polyorganosiloxane having at least two silicon-bonded alkenyl groups per molecule, (B) a polyorganosiloxane having at least two silicon-bonded hydrogen atoms per molecule, (C) water, (D) a thickening agent, (E) an emulsifier, (F) a halogen-containing ion conductor of an alkali metal, and (G) a hydrosilylation reaction catalyst. The sponge-formable silicone rubber composition can form a silicone rubber sponge having uniform and fine bubbles and having small distortion due to contraction after secondary vulcanization.

### TECHNICAL FIELD

The present invention relates to a sponge-formable silicone rubber composition, and to a silicone rubber sponge obtained by crosslinking of the composition by a hydrosilylation reaction.

### BACKGROUND ART

Due to having excellent heat resistance and weather resistance, being light-weight, and having low thermal conductivity, silicone rubber sponge is used in various seal materials such as packings, gaskets, and O-rings; rollers and belts of image forming devices such as copiers and printers; and automotive parts such as hood cushioning pads and engine vibration-proofing materials.

Silicone rubber compositions for forming such silicone rubber sponges that have been proposed include an emulsion composition for silicone rubber comprising a poly-diorganosiloxane having at least two silicon-bonded alkenyl groups per molecule, a polyorganosiloxane having at least two silicon-bonded hydrogen atoms per molecule, water containing smectite clay, an emulsifier, and a platinum-based catalyst (see Patent Document 1); a silicone rubber sponge-formable composition comprising a liquid polyorganosiloxane having at least two silicon-bonded alkenyl groups per molecule, a liquid polyorganohydrogensiloxane having at least two silicon-bonded hydrogen atoms per molecule, a surfactant, an addition reaction catalyst, a reinforcing silica fine powder, and water (see Patent Document 2); and a sponge-formable liquid silicone rubber composition comprising a polydiorganosiloxane capped at both molecular terminals with alkenyl groups and not containing an alkenyl group in side molecular chains, a polydiorganosiloxane having at least two alkenyl groups in side molecular chains, a polyorganosiloxane having at least two silicon-bonded hydrogen atoms per molecule, a mixture of water and an inorganic thickening agent, an emulsifier, a hydrosilylation reaction catalyst, and a curing retarder (see Patent Document 3). A silicone rubber sponge can be formed by curing such a silicone rubber composition in a uniform emulsified state and then removing water from the obtained silicone rubber.

However, the silicone rubber sponge obtained in such a manner has the problems that fineness and uniformity of sponge bubbles are not sufficient, and distortion is large due to non-uniform contraction after secondary vulcanization for removing water.

On the other hand, blending a lithium salt is a known method for imparting antistatic capability to silicone rubber (see Patent Documents 4 and 5).

However, lithium salt is for imparting antistatic capability without reducing rubber properties and compression set, and is not for improving compression set of silicone rubber. In particular, it is not known to reduce distortion due to contraction after secondary vulcanization of a silicone rubber sponge.

### CITATION LIST

### Patent Literature

Patent Document 1: Japanese Unexamined Patent Application Publication No. 2004-346248A

Patent Document 2: Japanese Unexamined Patent Application Publication No. 2005-062534A

Patent Document 3: Japanese Unexamined Patent Application Publication No. 2008-214625A

Patent Document 4: Japanese Unexamined Patent Application Publication No. 2006-265340A

Patent Document 5: Japanese Unexamined Patent Application Publication No. 2011-201951A

### SUMMARY OF INVENTION

### Technical Problem

An object of the present invention is to provide a sponge-formable silicone rubber composition that forms a silicone rubber sponge having uniform and fine bubbles and having small distortion due to contraction after secondary vulcanization, and such a silicone rubber sponge.

### Solution to Problem

The sponge-formable silicone rubber composition of the present invention comprises:

(A) 100 parts by mass of a polyorganosiloxane having at least two silicon-bonded alkenyl groups per molecule;

(B) a polyorganosiloxane having at least two silicon-bonded hydrogen atoms per molecule, in an amount such that silicon-bonded hydrogen atoms in component (B) is from 0.4 to 20 moles per 1 mole of alkenyl groups in component (A);

(C) from 20 to 500 parts by mass of water;

(D) a thickening agent, in an amount of from 0.01 to 15 parts by mass per 100 parts by mass of component (C);

(E) from 0.1 to 15 parts by mass of an emulsifier;

(F) from 0.00001 to 2.0 parts by mass of a halogen-containing ion conductor of an alkali metal; and

(G) a hydrosilylation reaction catalyst, in an amount to accelerate a hydrosilylation reaction of the composition.

The silicone rubber sponge of the present invention is obtained by crosslinking the composition by a hydrosilylation reaction and then removing water from the obtained silicone rubber, or removing water while crosslinking the composition by a hydrosilylation reaction.

### Effect of Invention

The sponge-formable silicone rubber composition of the present invention forms a silicone rubber sponge having uniform and fine bubbles and having small distortion due to contraction after secondary vulcanization. Furthermore, the silicone rubber sponge of the present invention has uniform and fine bubbles and having small distortion due to contraction after secondary vulcanization.

### DETAILED DESCRIPTION OF THE INVENTION

First, the sponge-formable silicone rubber composition of the present invention will be described in detail.

The polyorganosiloxane for component (A) is a base compound of the present composition and has at least two silicon-bonded alkenyl groups per molecule. Examples of the alkenyl groups in component (A) include alkenyl groups having from 2 to 8 carbons such as a vinyl group, an allyl group, an isopropenyl group, a butenyl group, an isobutenyl group, a pentenyl group, a hexenyl group, a heptenyl group, and an octenyl group, among which a vinyl group is preferred. The bonding position of the alkenyl groups may be a silicon atom at the end of the molecular chain and/or a silicon atom in the molecular chain, without limitation. The silicon atom at the end of the molecular chain is preferred. Furthermore, examples of silicon-bonded organic groups other than alkenyl groups in component (A) include alkyl groups having from 1 to 8 carbons such as a methyl group, an ethyl group, a propyl group, a butyl group, a pentyl group, a hexyl group, a heptyl group, and an octyl group; cycloalkyl groups having from 5 to 8 carbons such as a cyclopentyl group, a cyclohexyl group, a cycloheptyl group, and a cyclooctyl group; an aryl group having from 6 to 12 carbons such as a phenyl group, a tolyl group, a xylyl group, and a naphthyl group; an aralkyl having from 7 to 12 carbons such as a benzyl group and a phenethyl group; and monovalent hydrocarbon groups in which some or all of the hydrogen atoms in these monovalent hydrocarbon groups has been substituted with a halogen atom such as fluorine or chlorine. A methyl group or a phenyl group is preferred.

Examples of the molecular structure of component (A) include linear, partially branched linear, branched chain, cyclic, or resinoid, without limitation. Linear or partially branched linear is preferred. Component (A) is preferably a linear poly-organosiloxane capped at both molecular terminals with triorganosiloxy groups in which the main chain is composed of repeating diorganosiloxane units, of which the molecular structure may also be partially branched chain or cyclic.

Examples of such component (A) include dimethylpolysiloxanes capped at both molecular terminals with dimethylvinylsiloxy groups, dimethylpolysiloxanes capped at both molecular terminals with diphenylvinylsiloxy groups, dimethylsiloxane-methylphenylsiloxane copolymers capped at both molecular terminals with dimethylvinylsiloxy groups, dimethylsiloxane-diphenylsiloxane copolymers capped at both molecular terminals with dimethylvinylsiloxy groups, dimethylsiloxane-methylphenylsiloxane copolymers capped at both molecular terminals with diphenylvinylsiloxy groups, dimethylsiloxane-methylvinylsiloxane copolymers capped at both molecular terminals with dimethylvinylsiloxy groups, dimethylsiloxane-methylphenylsiloxane-methylvinylsiloxane copolymers capped at both molecular terminals with dimethylvinylsiloxy groups, dimethylsiloxane-diphenyl-siloxane-methylvinylsiloxane copolymers capped at both molecular terminals with dimethylvinylsiloxy groups, methylvinylpolysiloxanes capped at both molecular terminals with trimethylsiloxy groups, methylvinylsiloxane-methylphenylsiloxane copolymers capped at both molecular terminals with trimethylsiloxy groups, methylvinylsiloxane-diphenylsiloxane copolymers capped at both molecular terminals with trimethylsiloxy groups, and dimethylsiloxane-methylvinylsiloxane copolymers capped at both molecular terminals with trimethylsiloxy groups. A combination of two or more polyorganosiloxanes having the above molecular structures may also be used as component (A).

The viscosity of component (A) is not limited, but viscosity at 25° C. is preferably not less than 50 mPa·s or not less than 100 mPa·s, and not greater than 100,000 mPa·s. This is because if the viscosity of component (A) is not less than the afore-mentioned lower limit and not greater than the aforementioned upper limit, an emulsion of the obtained silicone rubber composition is stable and a silicone rubber sponge having uniform bubbles is readily obtained. Note that the viscosity at 25° C. of this polyorganosiloxane may be measured by, for example, a B-type viscometer in conformance with JIS K7117-1.

The polyorganosiloxane for component (B) is a crosslinking agent of the present composition and has at least two silicon-bonded hydrogen atoms per molecule. The silicon-bonded hydrogen atoms in component (B) may be bonded to silicon atoms at the end of the molecular chain and/or silicon atoms in the molecular chain. Examples of the molecular structure of component (B) include linear, partially branched linear, branched chain, cyclic, or resinoid, without limitation. Linear or partially branched linear is preferred. Linear polyorganosiloxanes are preferred as component (B).

Examples of such component (B) include dimethylpolysiloxanes capped at both molecular terminals with dimethylhydrogensiloxy groups, dimethylsiloxane-methylphenylsiloxane copolymers capped at both molecular terminals with dimethyl-hydrogensiloxy groups, dimethylsiloxane-methylhydrogensiloxane copolymers capped at both molecular terminals with dimethylhydrogensiloxy groups, dimethylsiloxane-methylhydrogensiloxane copolymers capped at both molecular terminals with trimethylsiloxy groups, organopolysiloxanes composed of H(CH₃)₂SiO_{1/2} units and SiO_{4/2} units, and organopolysiloxanes composed of H(CH₃)₂SiO_{1/2} units, (CH₃)₃SiO_{1/2} units, and SiO_{4/2} units.

The viscosity of component (B) is not limited, but kinetic viscosity at 25° C. is preferably not less than 1 mm²/s and not greater than 1000 mm²/s. Note that the kinetic viscosity at 25° C. of this polyorganosiloxane may be measured by, for example, an Ubbelohde viscometer in conformance with JIS Z8803.

The content of component (B) is a quantity whereby the amount of silicon-bonded hydrogen atoms in this component is from 0.4 to 20 moles per 1 mole of alkenyl groups in component (A). Preferably, the lower limit thereof is a quantity resulting in 1.0 mole, a quantity resulting in 1.5 moles, or a quantity resulting in 1.8 moles, while the upper limit thereof is a quantity resulting in 10 moles or a quantity resulting in 5.0 moles. This is because if the content of component (B) is within the aforementioned range, the compression set of the obtained silicone rubber sponge is improved.

The water for component (C) is for making the silicone rubber porous by being removed from the silicone rubber after the present composition is crosslinked The content of component (C) is in the range of 20 to 500 parts by mass per 100 parts by mass of component (A). Preferably, the lower limit thereof is 30 parts by mass, 40 parts by mass, or 50 parts by mass, while the upper limit thereof is 400 parts by mass, 300 parts by mass, or 200 parts by mass, per 100 parts by mass of component (A). This is because when the content of component (C) is not less than the lower limit of the aforementioned range, the obtained silicone rubber sponge tends to be porous and to have uniform bubbles, while when it is not greater than the upper limit of the afore-mentioned range, a silicone rubber sponge is easy to obtain.

The water for component (C) is not particularly limited, but tap water, well water, ion exchanged water, distilled water, or the like may be used. It is particularly preferred that component (C) be ion exchanged water from the perspective that dispersion in component (A) is stable.

The thickening agent for component (D) is for thickening the water of component (C), making it easy to disperse component (C) in component (A), stabilizing the dispersed state of component (C) in component (A), and making the obtained silicone rubber uniformly porous. Such component (D) is preferably at least one type selected from the group consisting of inorganic thickening agents, cellulose fibers, water-soluble polymers, water-absorbent polymers, hydrophilic composites composed of the above inorganic thickening agents and the above water-soluble polymers, and hydrophilic composites composed of the above inorganic thickening agents and the above water-absorbent polymers.

The inorganic thickening agents for component (D) are natural or synthetic inorganic thickening agents, examples of which include natural and synthetic smectite clays, such as bentonite containing a main component of clay minerals such as bentonite (montmorillonite), hectorite, saponite, sauconite, beidellite, and nontronite. Such smectite clays may be procured as the hydrothermal synthetic products Smecton (registered trademark of Kunimine Industries Co., Ltd.) and Lucentite (registered trademark of Co-Op Chemical Co., Ltd.), and the natural purified products Kunipia (registered trademark of Kunimine Industries Co., Ltd.), Bengel (registered trademark of Hojun Co., Ltd.), Bentone (trademark of Elementis PLC), and VEEGUM (trademark of Vanderbilt Minerals, LLC). This inorganic thickening agent is preferably bentonite (montmorillonite), hectorite, or saponite due to the fact that viscosity increases greatly when dispersed in water and the content of the emulsifier (E) can be reduced. The pH of these smectite clays is preferably in the range of 5.0 to 9.0 from the perspective of maintaining heat resistance of the silicone rubber sponge. Furthermore, a hydrophilic composite composed of such a smectite clay, and a water-absorbent polymer or a water-soluble polymer such as polyacrylic acid may also be used.

The cellulose fibers for component (D) are those that have been made into nanofibers by chemically or physically treating natural or synthetic cellulose fibers. From the perspectives of dispersibility, thickening properties, and the like, the number-average fiber diameter of such cellulose fibers is preferably in the range of 2 to 150 nm, in the range of 2 to 100 nm, or in the range of 2 to 10 nm. This is because when it is within the aforementioned range, the cellulose fibers do not readily settle when dispersed in water and can thicken while retaining fluidity.

The cellulose fibers for component (D) may be procured as an aqueous dispersion of cellulose nanofibers manufactured by Dai-ichi Kogyo Seiyaku Co., Ltd. (product name: Rheocrysta C-2SP).

Examples of the water-soluble polymer for component (D) include alginic acid, sodium alginate, carboxylate sodium salts, carboxycellulose sodium salts, methyl-cellulose, cellulose ethers, hydroxyethylcellulose, modified starch, polyvinyl alcohols, polacrylates, or polyacrylate sodium salts.

Furthermore, examples of the water-absorbent polymer for component (D) include polyacrylic acid salt crosslinked products and polyoxyalkylene-based water-absorbent resins.

The content of component (D) is in the range of 0.01 to 15 parts by mass per 100 parts by mass of component (C), and preferably, the lower limit thereof is 0.05 parts by mass or 0.1 parts by mass, while the upper limit thereof is 10 parts by mass or 5 parts by mass. This is because when the content of component (D) is not less than the lower limit of the aforementioned range, it can sufficiently thicken the water of component (C), and when not greater than the upper limit of the aforementioned range, it can stabilize emulsification of the silicone rubber composition.

The emulsifier for component (E) is for uniformly emulsifying the water in the silicone rubber composition and making the obtained silicone rubber uniformly porous. Examples of component (E) include anionic, cationic, amphoteric, and nonionic emulsifiers, and specifically, nonionic surfactants such as glycerin fatty acid esters, polyglycerin fatty acid esters, sorbitan fatty acid esters, sucrose fatty acid esters, polyethylene glycol fatty acid esters, polypropylene glycol fatty acid esters, poly-oxyethylene glycerin fatty acid esters, polyoxyethylene sorbitan fatty acid esters, poly-oxyethylene-polyoxypropylene block copolymers, polyoxyethylene alkyl ethers, polyoxyethylene alkyl phenyl ethers, and polyoxyethylene fatty acid amides; nonionic surfactants composed of polyorganosiloxanes such as polysiloxane-polyoxyethylene graft copolymers; cationic surfactants such as aliphatic amine salts, quaternary ammonium salts, and alkyl pyridinium salts; anionic surfactants such as higher fatty acid salts, higher alcohol sulfuric acid ester salts, alkylbenzene sulfonic acid salts, alkyl-naphthalene sulfonic acid salts, and polyethylene glycol sulfuric acid ester salts; and amphoteric surfactants such as carboxybetaine-based and glycine-based surfactants. Nonionic emulsifiers are particularly preferred because they have little effect on cros slinking via the hydrosilylation reaction of the present composition.

These emulsifiers may be used as one type alone or in a combination of two or more types. The HLB value of the emulsifier (when a combination of two or more types of emulsifiers are used in combination, the weight-average HLB value thereof) is preferably not less than 1 and not greater than 10, not less than 1.5 and less than 6, or not less than 3.5 and less than 6.

The content of component (E) is in the range of 0.1 to 15 parts by mass per 100 parts by mass of component (A), and preferably, the lower limit thereof is 0.2 parts by mass, while the upper limit thereof is 10 parts by mass, 5 parts by mass, or 3 parts by mass. This is because when the content of component (E) is not less than the lower limit of the aforementioned range, component (C) can be uniformly dispersed in component (A), while on the other hand, when it is not greater than the upper limit of the afore-mentioned range, there is no effect on the mechanical characteristics or electrical characteristics of the obtained silicone rubber sponge.

The halogen-containing ion conductor of an alkali metal for component (F) is for reducing distortion due to contraction after secondary vulcanization of the silicone rubber sponge obtained by crosslinking the present composition. Such component (F) is preferably a halogen-containing ion conductor of lithium or sodium, specific examples of which include MBF₄, MClO₄, MPF₆, MAsF₆, MSbF₆, MSO₃CF₃, MN(SO₂CF₃)₂, ^{MSO}₃C₄F₉, MC(SO₂CF₃)₃, MB(C₆H₅)₄, and mixtures of two or more types thereof. Note that in the formulas, M is lithium (Li) or sodium (Na).

The content of component (F) is in the range of 0.00001 to 1.0 parts by mass per 100 parts by mass of component (A), and preferably, the lower limit thereof is 0.0001 parts by mass, while the upper limit thereof is 0.5 parts by mass. This is because when the content of component (F) is not less than the lower limit of the aforementioned range, the distortion after secondary vulcanization can be reduced, while when it is not greater than the upper limit of the aforementioned range, a silicone rubber sponge having uniform and fine bubbles can be formed without adversely affecting dispersibility of component (C) in component (A).

The hydrosilylation reaction catalyst for component (G) is a catalyst for hydrosilylation of the present composition. Examples include platinum-based catalysts such as chloroplatinic acid, alcohol-modified chloroplatinic acid, coordinate compounds of chloroplatinic acid with olefins, vinylsiloxanes, and acetylene compounds, and powder platinum-based catalysts in which they are dispersed in a thermoplastic resin; palladium-based catalysts such as tetrakis(triphenylphosphine)palladium; and rhodium-based catalysts such as chlorotris(triphenylphosphine)rhodium. Platinum-based catalysts are preferred.

The content of component (G) is a quantity that accelerates a hydrosilylation reaction of the present composition, and is preferably a quantity whereby the catalytic metal in component (G) is in the range of 0.01 to 500 ppm, or in the range of 0.1 to 100 ppm, relative to the total amount of components (A) and (B).

The present composition may further contain a hydrosilylation reaction inhibitor (H) for the purpose of adjusting the crosslinking speed and pot life of the present composition. Examples of component (H) include alkyne alcohols such as 3-methyl-1-butyn-3-ol, 3,5-dimethyl-1-hexyn-3-ol, 3-phenyl-1-butyn-3-ol, and 1-ethynyl-1-cyclohexanol; ene-yne compounds such as 3-methyl-3-penten-1-yne and 3,5-dimethyl-3-hexen-1-yne; alkenyl group-containing low molecular weight siloxanes such as tetramethyltetravinylcyclotetrasiloxane and tetramethyltetrahexenylcyclote-trasiloxane; and alkyne-containing silanes such as methyl-tris(1,1-dimethyl-2-butynoxy)silane and vinyl-tris(1,1-dimethyl-2-butynoxy)silane.

The content of component (H) in the present composition is selected as appropriate without limitation according to the usage method and molding method of the present composition, but is preferably within the range of 0.001 to 5 parts by mass relative to 100 parts by mass of component (A) because the cros slinking speed and pot life of the present composition can be sufficiently adjusted.

The present composition may further contain reinforcing silica fine powder (I) for the purpose of improving the mechanical strength of the obtained silicone rubber sponge. Examples of component (I) include fumed silica and precipitated silica. Furthermore, these silica fine powders may also be surface-treated with linear polyorganosiloxane, cyclic polyorganosiloxane, hexamethyldisilazane, various organosilanes, and the like. Additionally, the specific surface area of component (I) according to the BET adsorption method is preferably from 50 to 350 m²/g or from 80 to 250 m²/g.

The content of component (I) is preferably not greater than 30 parts by mass, not greater than 20 parts by mass, not greater than 15 parts by mass, or not greater than 10 parts by mass, per 100 parts by mass of component (A). This is because when the content of component (I) is not greater than the upper limit of the aforementioned range, mechanical strength can be improved without losing uniformity and fineness of the obtained silicone rubber sponge.

The present composition may also contain an electrically conductive filler for the purpose of imparting electrical conductivity to the obtained silicone rubber sponge. Examples of the electrically conductive filler include carbon-based conductive agents such as carbon black, carbon fibers, carbon nanotubes, and graphite; metal powders such as gold, silver, and nickel; electrically conductive zinc oxide, electrically conductive titanium oxide, and electrically conductive aluminum oxide; electrically conductive fillers obtained by treating the surface of various fillers with electrically conductive coating such as metal plating treatment; and mixtures of two or more types thereof. This electrically conductive filler is preferably carbon black because good electrical conductivity is obtained by adding a small amount. Specific examples include acetylene black, conductive furnace black (CF), superconductive furnace black (SCF), extraconductive furnace black (XCF), conductive channel black (CC), and furnace black or channel black that has been heat treated at a high temperature of approximately 1500° C. The content of this electrically conductive filler is not limited, but is preferably not greater than 100 parts by mass or not greater than 70 parts by mass per 100 parts by mass of component (A) because a good sponge can be obtained.

As other optional components, the present composition may also contain reinforcing fillers other than silica, such as fumed titanium oxide; non-reinforcing fillers such as quartz powder, diatomaceous earth, aluminosilicate, iron oxide, zinc oxide, calcium carbonate, aluminum oxide, cerium oxide, mica, clay, and zinc carbonate; fillers obtained by surface-treating these fillers with organosilicon compounds such as organosilanes and polyorganosiloxanes; and preservatives, corrosion inhibitors, pigments, heat resistance agents, flame retardants, internal release agents, plasticizers, acid acceptors, and non-functional silicone oils, as long as the object of the present invention is not lost.

The present composition may be prepared by mixing components (A) through (G) and the other optional components as necessary. To prepare the present composition, a known kneading means such as homomixer, paddle mixer, homo-disper, colloid mill, or vacuum kneading and mixing machine may be used. Examples of methods for preparing the present composition include a method of loading component (A), component (B), component (C), component (D), component (E), and component (F) in a mixer, stiffing to mix for a prescribed time, and mixing in component (G) immediately before use using a mixing apparatus such as, for example, a static mixer or dynamic mixer; a method of loading component (A), component (C), component (D), component (E), component (F), and component (G) in a mixer, stirring to mix for a prescribed time, and mixing in component (B) immediately before use using a mixing apparatus such as, for example, a static mixer or dynamic mixer; and a method of loading component (A), component (C), component (D), component (E), and component (F) in a mixer, stirring to mix for a prescribed time, and mixing in component (B) and component (G) immediately before use using a mixing apparatus such as, for example, a static mixer or dynamic mixer.

Furthermore, from the perspective of storage stability, when preparing the present composition, it is preferable to store it as a three-part sponge-formable silicone rubber composition composed of

part A: composition composed of component (A), component (C), component (D), component (E), component (F), and component (G), and not containing component (B);

part B: composition composed of component (A), component (C), component (D), and component (E), and not containing component (B) and component (G); part C: composition composed of component (B), and not containing component (C), component (D), component (E), component (F), and component (G); or

a three-part sponge-formable silicone rubber composition composed of

part A′: composition composed of component (A), component (G), and, as necessary, component (E), and not containing component (B), component (C), and component (D);

part B′: composition composed of component (B), and, as necessary, component (E), and not containing component (C), component (D), and component (G);

part C′: composition composed of component (C), component (D), and, as necessary, component (F), and not containing component (A), component (B), and component (G);

and to mix the three parts using a mixing apparatus such as, for example, a static mixer or dynamic mixer immediately before submitting to molding. Furthermore, it is preferable to store it as a two-part sponge-formable silicone rubber composition composed of

part A″: composition composed of component (A), component (C), component (D), component (E), component (F), and component (G), and not containing component (B);

part B″: composition composed of component (B), and not containing component (C), component (D), component (E), component (F), and component (G); and to mix the two parts using a mixing apparatus such as, for example, a static mixer or dynamic mixer immediately before submitting to molding.

The silicone rubber sponge may be formed from the present composition by various methods. Specifically, after the present composition is uniformly emulsified, it is injected into the cavity of a mold for molding, and a silicone rubber molded body is molded in the water-containing state under pressure while holding the temperature at less than 100° C., preferably 50 to 90° C. It is then removed from the mold and submitted to secondary vulcanization at 120 to 250° C. to remove the water from the silicone rubber molded body in the water-containing state, and a silicone rubber sponge having fine and uniform bubbles is thereby obtained. Furthermore, a string-like silicone rubber sponge may be produced by discharging the present composition from a nozzle into a rod shape and curing it by introducing it into hot water at a temperature of, for example 80 to 100° C., and then drying the cured product with hot air. Additionally, a silicone rubber sponge sheet may be formed by coating a releasable substrate such as a resin film with the present composition and curing it by heating to a temperature of, for example 50 to 120° C., and removing water by drying with hot air, or, curing while removing water by heating and then removing the releasable substrate. Alternatively, a silicone rubber sponge coated textile may be formed by coating a synthetic fiber textile or glass cloth with the present composition, curing it by heating to a temperature of, for example 50 to 120° C., and removing water by drying with hot air, or, curing while removing water by heating.

The silicone rubber sponge of the present invention will now be described in detail.

The silicone rubber sponge of the present invention is obtained by crosslinking the above-described sponge-formable silicone rubber composition by a hydrosilylation reaction and then removing water from the obtained silicone rubber, or removing water while crosslinking the composition by a hydrosilylation reaction.

The silicone rubber sponge of the present invention is useful as an elastic material of the fixing member of an image forming device. In the case of a fixing roller, there is a silicone rubber sponge layer on a core, but in this case, the material and the dimensions of the core and so forth may be selected as appropriate according to the type of roller. In the case of a fixing belt, there is a silicone rubber sponge layer on an endless belt, but in this case, the material and the dimensions of the endless belt and so forth may be selected as appropriate according to the type of belt.

Additionally, a fluoro resin layer or fluorine rubber layer may be further provided on the outer circumference of the silicone rubber sponge layer. In this case, the fluoro resin layer is formed of a fluoro resin coating material or a fluoro resin tube and coats the silicone rubber sponge layer. Examples of the fluoro resin coating material include latex of polytetrafluoroethylene resin (PTFE) and DAI-EL Latex (fluorine-based latex manufactured by Daikin Industries, Ltd.). Examples of the fluoro resin tube include polytetrafluoroethylene resin (PTFE), tetrafluoroethylene-perfluoroalkyl vinyl ether copolymer resin (PFA), ethylene fluoride-polypropylene copolymer resin (FEP), polyvinylidene fluoride resin (PVDF), and polyvinyl fluoride resin.

The thickness of the silicone rubber sponge layer is not limited but is preferably in the range of 0.05 to 80 mm or in the range of 0.1 to 50 mm because rubber elasticity is effectively utilized. The thickness of the fluoro resin or fluorine rubber layer formed on top of it is preferably in the range of 5 to 200 μm or in the range of 10 to 100 μm.

### EXAMPLES

The sponge-formable silicone rubber composition and silicone rubber sponge of the present invention will be described in further detail through examples. Note that the viscosity in the examples is the value at 25° C. Furthermore, the characteristics of the silicone rubber sponge in the examples are the values measured as follows.

<Viscosity>

The viscosity at 25° C. (mPa·s) of the polyorganosiloxane is the value measured by a B-type viscometer in conformance with JIS K7117-1, and the kinetic viscosity (mm²/s) is the value measured by an Ubbelohde viscometer in conformance with JIS Z8803.

<Density>

The density was measured in conformance with JIS K6268.

<Hardness>

The hardness was measured using a test piece 6 mm thick in conformance with the test method using a C-type tester (Asker C durometer) set forth in JIS K7312.

<Tensile Strength, Elongation>

The tensile strength and elongation were measured in conformance with JIS K6251.

<Compression set>

The compression set was measured after 22 hours at 180° C. and 25% compression in conformance with JIS K6262.

<Contraction Rate>

The thickness of the center portion and the thickness of the end portion of a test piece for compression set measurement, which was molded using a mold having a cavity with a diameter of 29 mm and thickness of 12.8 mm, was measured and substituted into the following formula to determine the contraction rate.

$$Contraction Rate = \frac{12.8 - Measured Value ( mm )}{12.8} \times 100 \qquad [ Math . 1 ]$$

### Preparation Example 1

### (Preparation of Silica Master Batch)

100 parts by mass of polydimethylsiloxane capped at both molecular terminals with dimethylvinylsiloxy groups having a viscosity of 40,000 mPa·s, 50 parts by mass of fumed silica having a BET specific surface area of 400 m²/g, 10 parts by mass of hex-amethyldisilazane, 0.36 parts by mass of tetramethyldivinylsilazane, 2 parts by mass of water, and 0.26 parts by mass of dimethylsiloxane-methylvinylsiloxane copolymer capped at both molecular terminals with dimethylhydroxysiloxy groups having a viscosity of 20 mPa·s (vinyl group content approximately 10.9 mass %) were loaded in a Ross mixer, and after mixing until uniform at room temperature, it was kneaded while heating at 200° C. under reduced pressure for 2 hours, to prepare a fluid silica master batch.

### Preparation Example 2

(Preparation of Aqueous Dispersion Thickened with Inorganic Thickening Agent)

0.85 parts by mass of smectite clay (organic polymer composite hydrophilic purified bentonite manufactured by Hojun Co., Ltd.; pH 6.5) and 99.15 parts by mass of ion exchanged water were loaded in a homomixer and mixed at room temperature until uniform, to prepare an aqueous dispersion (c-1) thickened with an inorganic thickening agent.

### Preparation Example 3

(Preparation of Aqueous Dispersion Thickened with Cellulose Nanofibers)

10 parts by mass of a 2% aqueous dispersion of cellulose nanofibers (number-average fiber diameter 4 nm) (product name Rheocrysta C-2SP manufactured by Dai-ichi Kogyo Seiyaku Co., Ltd.) and 20 parts by mass of ion exchanged water were loaded in a homomixer and mixed at room temperature until uniform, to prepare an aqueous dispersion (c-2) thickened with cellulose nanofibers.

### Working Examples 1 to 10 and Comparative Examples 1 to 3

The silica master batch, component (A), component (C), component (D), component (E), and component (F) were loaded into a homomixer (manufactured by Tokushu Kika Kogyo Co., Ltd.) in the compositions (parts by mass) listed in Tables 1 to 3, and mixed until uniform at 25° C. Then, component (B), component (G), and component (H) were mixed into the obtained mixture in the compositions (parts by mass) listed in Tables 1 to 3 and degassed to prepare sponge-formable silicone rubber compositions. Note that in Tables 1 to 3, SiH/V indicates the number of moles of silicon-bonded hydrogen atoms in the polyorganosiloxane equivalent to component (B) relative to 1 mole of vinyl groups in the polyorganosiloxane equivalent to component (A) in the silicone rubber composition.

The sponge-formable silicone rubber compositions prepared in this manner were crosslinked for 10 minutes at 90° C. using a compression molding machine, to prepare various test pieces in the water-containing state. Next, these test pieces were left to stand in an open system for 4 hours at 200° C. to remove the water in the test pieces, to produce silicone rubber sponge test pieces. Using these silicone rubber sponge test pieces, density, hardness, tensile strength, elongation, compression set, and contraction rate were measured. The results are shown in Tables 1 to 3.

Silica MB: Silica master batch prepared in Preparation Example 1 (fumed silica content approximately 31 mass %)

(a-1): Dimethylsiloxane-methylvinylsiloxane copolymer capped at both molecular terminals with trimethylsiloxy groups, having a viscosity of 10,000 mPa·s (vinyl group content 0.13 mass %)

(a-2): Dimethylsiloxane-methylvinylsiloxane copolymer capped at both molecular terminals with dimethylvinylsiloxy groups, having a viscosity of 350 mPa·s (vinyl group content approximately 1.17 mass %)

(b-1): Dimethylsiloxane-methylhydrogensiloxane copolymer capped at both molecular terminals with trimethylsiloxy groups, having a kinetic viscosity of 43.5 mm ²/s (silicon-bonded hydrogen atom content approximately 0.69 mass %)

(c-1): Aqueous dispersion thickened with inorganic thickening agent prepared in Preparation Example 2 (smectite clay content 0.85 mass %)

(c-2): Aqueous dispersion thickened with cellulose nanofibers prepared in Preparation Example 3 (cellulose nanofiber content 0.67 mass %)

(d-1): Nonionic surfactant (sorbitan fatty acid ester, product name Rheodol SP-010V manufactured by Kao Corp.; HLB value 4.3)

(d-2): Nonionic surfactant (sorbitan fatty acid ester, product name Rheodol SP-030V manufactured by Kao Corp.; HLB value 1.8)

(e-1): LiN(SO₂CF₃)₂

(e-2): NaN(SO₂CF₃)₂

(e-3): LiPF₆

(f-1): 1,3-divinyltetramethyldisiloxane solution of 1,3-divinyltetramethyldisiloxane complex of platinum (platinum metal content approximately 4000 ppm)

(g-1): Mixture of 2 parts by mass of ethynylcyclohexanol and 98 parts by mass of polydimethylsiloxane capped at both molecular terminals with dimethylvinylsiloxy groups having a viscosity of 10,000 mPa·s

Pigment MB: Mixture of 40 parts by mass of Bengara (product name Bayferrox man-ufactured by Bayer AG) and 60 parts by mass of polydimethylsiloxane capped at both molecular terminals with dimethylvinylsiloxy groups having a viscosity of 10,000 mPa·s

TABLE 1

| | | Category | | | |
|---|---|---|---|---|---|
| | | Working Example | | Comparative Example | |
| Item | | 1 | 2 | 1 | 2 |
| Composition | Silica MB | 43.9 | 43.9 | 43.9 | 43.9 |
| of silicone | (a-1) | 26.3 | 26.3 | 26.3 | 26.3 |
| rubber | (a-2) | 43.4 | 43.4 | 43.4 | 43.4 |
| composition | (b-1) | 14.8 | 14.8 | 14.8 | 14.8 |
| (parts | (c-1) | 136.4 | — | 136.4 | — |
| by mass) | (c-2) | — | 136.4 | — | 136.4 |
| | (d-1) | 1.03 | 1.03 | 1.03 | 1.03 |
| | (d-2) | 0.06 | 0.06 | 0.06 | 0.06 |
| | (e-1) | 0.13 | 0.13 | — | — |
| | (f-1) | 0.39 | 0.39 | 0.39 | 0.39 |
| | (g-1) | 0.38 | 0.38 | 0.38 | 0.38 |
| | Pigment MB | 5.5 | 5.5 | 5.5 | 5.5 |

| | | | | |
|---|---|---|---|---|
| SiH/Vi | 4.4 | 4.4 | 4.4 | 4.4 |
| Density (g/cm³) | 0.569 | 0.649 | 0.601 | 0.664 |
| Hardness | 46 | 47 | 48 | 49 |
| Tensile strength (MPa) | 0.9 | 1.3 | 1.3 | 1.4 |
| Elongation (%) | 52 | 49 | 60 | 49 |
| Compression set (%) | 26 | 49 | 38 | 43 |
| Contraction rate of | 3.4 | 9.6 | 16.2 | 15.8 |
| center portion (%) | | | | |
| Contraction rate of | 3.4 | 8.4 | 8.3 | 7.1 |
| end portion (%) | | | | |

TABLE 2

| | | Category | | | |
|---|---|---|---|---|---|
| | | | | | Comparative |
| | | Working Example | | | Example |
| Item | | 3 | 4 | 5 | 3 |
| Composition | Silica MB | 52.4 | 52.4 | 52.4 | 52.4 |
| of silicone | (a-1) | 14.0 | 14.0 | 14.0 | 14.0 |
| rubber | (a-2) | 50.0 | 50.0 | 50.0 | 50.0 |
| composition | (b-1) | 14.6 | 14.6 | 14.6 | 14.6 |
| (parts | (c-1) | 140.0 | 140.0 | 140.0 | 140.0 |
| by mass) | (d-1) | 1.1 | 1.1 | 1.1 | 1.1 |
| | (d-2) | 0.07 | 0.07 | 0.07 | 0.07 |
| | (e-1) | 0.13 | — | — | — |
| | (e-2) | — | 0.13 | — | — |
| | (e-3) | — | — | 0.13 | — |
| | (f-1) | 0.42 | 0.42 | 0.42 | 0.42 |
| | (g-1) | 0.41 | 0.41 | 0.41 | 0.41 |
| | Pigment MB | 5.8 | 5.8 | 5.8 | 5.8 |

| | | | | |
|---|---|---|---|---|
| SiH/Vi | 3.9 | 3.9 | 3.9 | 3.9 |
| Density (g/cm³) | 0.569 | 0.585 | 0.587 | 0.632 |
| Hardness | 50 | 50 | 50 | 51 |
| Tensile strength (MPa) | 1.3 | 1.3 | 1.2 | 1.5 |
| Elongation (%) | 56 | 56 | 51 | 55 |
| Compression set (%) | 20 | 29 | 31 | 37 |
| Contraction rate of | 4.1 | 13.6 | 13.7 | 17.2 |
| center portion (%) | | | | |
| Contraction rate of | 3.9 | 7.2 | 6.8 | 8.4 |
| end portion (%) | | | | |

TABLE 3

| | | Category | | | | |
|---|---|---|---|---|---|---|
| | | Working Example | | | | |
| Item | | 6 | 7 | 8 | 9 | 10 |
| Compo- | Silica MB | 52.4 | 52.4 | 52.4 | 52.4 | 52.4 |
| sition of | (a-1) | 14.0 | 14.0 | 14.0 | 14.0 | 14.0 |
| silicone | (a-2) | 50.0 | 50.0 | 50.0 | 50.0 | 50.0 |
| rubber | (b-1) | 14.6 | 14.6 | 14.6 | 14.6 | 14.6 |
| compo- | (c-1) | 140.0 | 140.0 | 140.0 | 140.0 | 140.0 |
| sition | (d-1) | 1.1 | 1.1 | 1.1 | 1.1 | 1.1 |
| (parts | (d-2) | 0.07 | 0.07 | 0.07 | 0.07 | 0.07 |
| by mass) | (e-1) | 0.0002 | 0.004 | 0.04 | 0.26 | 0.39 |
| | (f-1) | 0.42 | 0.42 | 0.42 | 0.42 | 0.42 |
| | (g-1) | 0.41 | 0.41 | 0.41 | 0.41 | 0.41 |
| | Pigment | 5.8 | 5.8 | 5.8 | 5.8 | 5.8 |
| | MB | | | | | |

| | | | | | |
|---|---|---|---|---|---|
| SiH/Vi | 3.9 | 3.9 | 3.9 | 3.9 | 3.9 |
| Density (g/cm³) | 0.574 | 0.588 | 0.573 | 0.566 | 0.568 |
| Hardness | 50 | 50 | 51 | 50 | 48 |
| Tensile strength | 1.1 | 1.3 | 1.1 | 1.3 | 1.2 |
| (MPa) | | | | | |
| Elongation (%) | 49 | 54 | 51 | 60 | 57 |
| Compression set (%) | 27 | 26 | 23 | 20 | 26 |
| Contraction rate of | 8.6 | 6.5 | 9.2 | 5.4 | 6.2 |
| center portion (%) | | | | | |
| Contraction rate of | 7.4 | 6.5 | 7.2 | 6.0 | 6.1 |
| end portion (%) | | | | | |

### INDUSTRIAL APPLICABILITY

Since the sponge-formable silicone rubber composition of the present invention has excellent moldability and can form a silicone rubber sponge having a low contraction rate after molding and little distortion after secondary vulcanization, it is advantageously used in elastic materials of rollers and belts used in image forming devices such as electronic photographic copiers, laser printers, on-demand printers, and facsimile machines, and sponge applications used at high temperature such as thermal insulation materials, sound absorbing materials, cushioning, packing, gaskets, and pads.

1. A sponge-formable silicone rubber composition comprising:
(A) 100 parts by mass of a polyorganosiloxane having at least two silicon-bonded alkenyl groups per molecule;
(B) a polyorganosiloxane having at least two silicon-bonded hydrogen atoms per molecule, in an amount such that an amount of silicon-bonded hydrogen atoms in component (B) is from 0.4 to 20 moles per 1 mole of alkenyl groups in component (A);
(C) from 20 to 500 parts by mass of water;
(D) a thickening agent, in an amount of from 0.01 to 15 parts by mass per 100 parts by mass of component (C);
(E) from 0.1 to 15 parts by mass of an emulsifier;
(F) from 0.00001 to 2.0 parts by mass of a halogen-containing ion conductor of an alkali metal; and
(G) a hydrosilylation reaction catalyst, in an amount to accelerate a hydrosilylation reaction of the composition.

2. The sponge-formable silicone rubber composition according to claim 1, wherein component (D) is at least one type of thickening agent selected from the group consisting of inorganic thickening agents, cellulose fibers, water-soluble polymers, water-absorbent polymers, hydrophilic composites composed of the inorganic thickening agents and the water-soluble polymers, and hydrophilic composites composed of the inorganic thickening agents and the water-absorbent polymers.

3. The sponge-formable silicone rubber composition according to claim 2, wherein the inorganic thickening agent for component (D) is smectite clay.

4. The sponge-formable silicone rubber composition according to claim 1, wherein component (F) is at least one type of ion conductor selected from the group consisting of MBF₄, MClO₄, MPF₆, MAsF₆, MSbF₆, MSO₃CF₃, MN(SO₂CF₃)₂, MSO₃C₄F₉, MC(SO₂CF₃)₃, and MB(C₆H₅)₄, wherein M in the formulas is lithium or sodium.

5. The sponge-formable silicone rubber composition according to claim 1, further comprising (H) a hydrosilylation reaction inhibitor, in an amount of 0.001 to 5 parts by mass per 100 parts by mass of component (A).

6. The sponge-formable silicone rubber composition according to claim 1, further comprising (I) a reinforcing silica fine powder, in an amount of not greater than 30 parts by mass per 100 parts by mass of component (A).

7. A silicone rubber sponge obtained by crosslinking the sponge-formable silicone rubber composition according to claim 1 by a hydrosilylation reaction and then removing water from the obtained silicone rubber, or removing water while crosslinking the composition by a hydrosilylation reaction.

8. The silicone rubber sponge according to claim 7, wherein the sponge is a silicone rubber sponge for a fixing member for an image forming device.

9. The sponge-formable silicone rubber composition according to claim 3, wherein component (F) is at least one type of ion conductor selected from the group consisting of MBF₄, MClO₄, MPF₆, MAsF₆, MSbF₆, MSO₃CF₃, MN(SO₂CF₃)₂, MSO₃C₄F₉, MC(SO₂CF₃)₃, and MB(C₆H₅)₄, wherein M in the formulas is lithium or sodium.

10. The sponge-formable silicone rubber composition according to claim 9, further comprising (H) a hydrosilylation reaction inhibitor, in an amount of 0.001 to 5 parts by mass per 100 parts by mass of component (A).

11. The sponge-formable silicone rubber composition according to claim 10, further comprising (I) a reinforcing silica fine powder, in an amount of not greater than 30 parts by mass per 100 parts by mass of component (A).

12. The sponge-formable silicone rubber composition according to claim 5, further comprising (I) a reinforcing silica fine powder, in an amount of not greater than 30 parts by mass per 100 parts by mass of component (A).
